(19) United States
(12) Patent Application Publication
(10) Pub. No.: US 2002/0025806 A1
(43) Pub. Date: Feb. 28, 2002

(54) Network management server

(75) Inventor: Markus Gerber, Esslingen (DE)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/899,279

(22) Filed: Jul. 6, 2001

(30) Foreign Application Priority Data
Jul. 7, 2000 (DE) 100 33 289.7

(51) Int. Cl. H04Q 7/20

(52) U.S. Cl. 455/422; 455/410

(57) ABSTRACT

The invention concerns a process for supporting the management of a communication network (KN1) and a network management server for implementing the process. The setting-up of a communication connection between a mobile radio terminal (TE1 to TE3) of a subscriber (A, B, C) of the communication network (KN1) and a network management server (NMS) of the communication network (KN1) is initiated by the mobile terminal (TE1 to TE3). The network management server (NMS) communicates with the mobile radio terminal (TE1 to TE3) via the initiated communication connection by means of a WAP protocol. The network management server (NMS1) determines the identity of the subscriber (A, B, C) and checks the authorisation of the ascertained subscriber (A, B, C) by means of an authorisation procedure. With satisfactory authorisation, the network management server (NMS1) allows and facilitates for the mobile radio terminal (TE1 to TE3) access by means of the WAP protocol to data assigned to the ascertained subscriber (A, B, C), in a subscriber management database (SMDB) of the network management system (NMS) of the communication network (KN1), in which the type of services subscribed to by the subscriber within the communication network, and respective assigned parameters for the management of the communication network, are specified by the network management system.

The invention concerns a method for supporting the management of a communication network, as well as a network management server for supporting the management of a communication network.

The invention is based on a conventional network management system for telecommunication networks, such as described in the article “Telecommunication Management Network (TMN): Architecture, interfaces and application”, ntz vol. 43, issue 6, pages 466 to 469, by Rüdiger Falkner and Harald Müller.

The network management system is used to support the management of a telecommunication network and the services provided in this telecommunication network. For this the network management system makes management functions available for telecommunication networks and services and supports communication between these management functions. From the point of view of architecture, the network management system consists of network management centres and operating consoles of the network operator of the telecommunication network, which communicate with the network elements of the telecommunication network via a data communication network. The network operator's operating personnel communicate exclusively with the network management centres via the operating consoles. Since every access to the network management centres can have a considerable influence on the mode of operation of the telecommunication network, special security precautions are taken within the network management system to grant access via the operating consoles to network management functions only to the network operator's authorised operating personnel.

The object of the invention is now to optimise the management of a communication network and the services provided within the communication network.

This object is achieved by a method for supporting the management of a communication network according to the teaching of claim 1, as well as by a network management server for supporting the management of a communication network according to the teaching of claim 8.

In this connection, the invention is based on the concept of allowing subscribers of a communication network direct access to special subscriber management functions of the network management system by means of a mobile radio terminal via a WAP protocol. In this case the term WAP protocol stands for a protocol which allows the transmission of XML (Extended Markup Language) content, for example WTML (Wireless Terminal Markup Language) or HTML (Hypertext Markup Language) via the radio interface of a cellular radio network. Examples of a WAP protocol are the Wireless Application Protocol (WAP) based on the GSM standard or corresponding protocols of the UMTS standard for the transmission of XML content via the radio interface in a UMTS communication system.

The advantage of the invention is on the one hand that it allows more effective management of the communication network that is better matched to the requirements of the subscribers of the communication network.

Furthermore, it is possible for the subscribers to adapt the management of the communication network from any location and at any time, so that the management of the communication network can be matched extremely rapidly to changed subscriber requirements.

Moreover, it is also possible for a subscriber to access specific network management data at any time and at any location, and thus be informed about the current status. This increases the customer friendliness of the management of the communication network.

Advantageous developments of the invention are revealed in the sub-claims.

The invention is explained below by means of several exemplary embodiments and the aid of the attached drawings, of which:

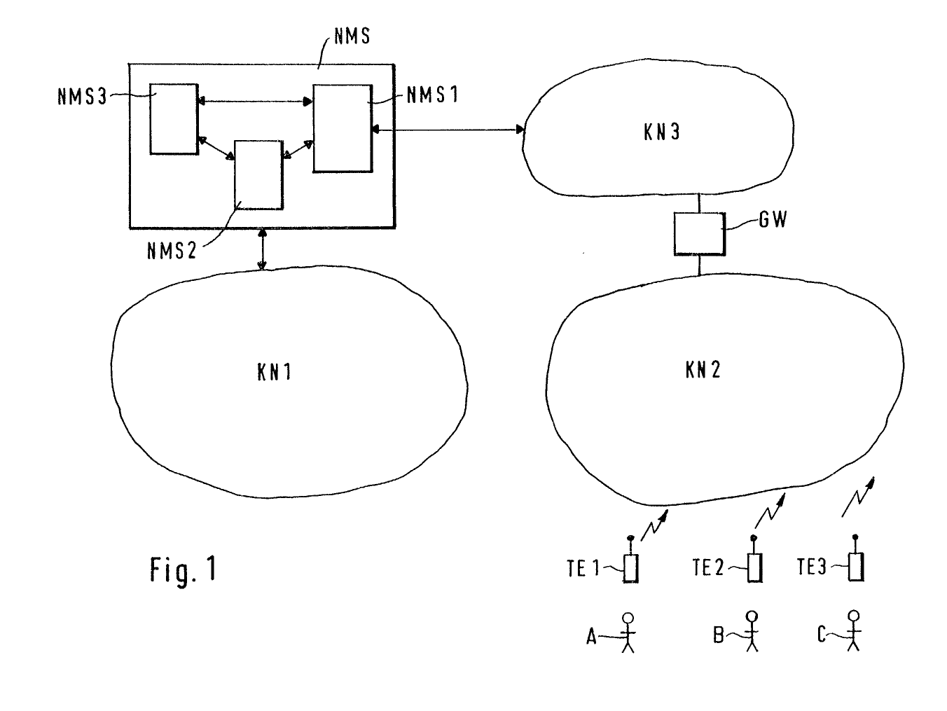

FIG. 1 shows a block diagram of a communication system with a network management server according to the invention.

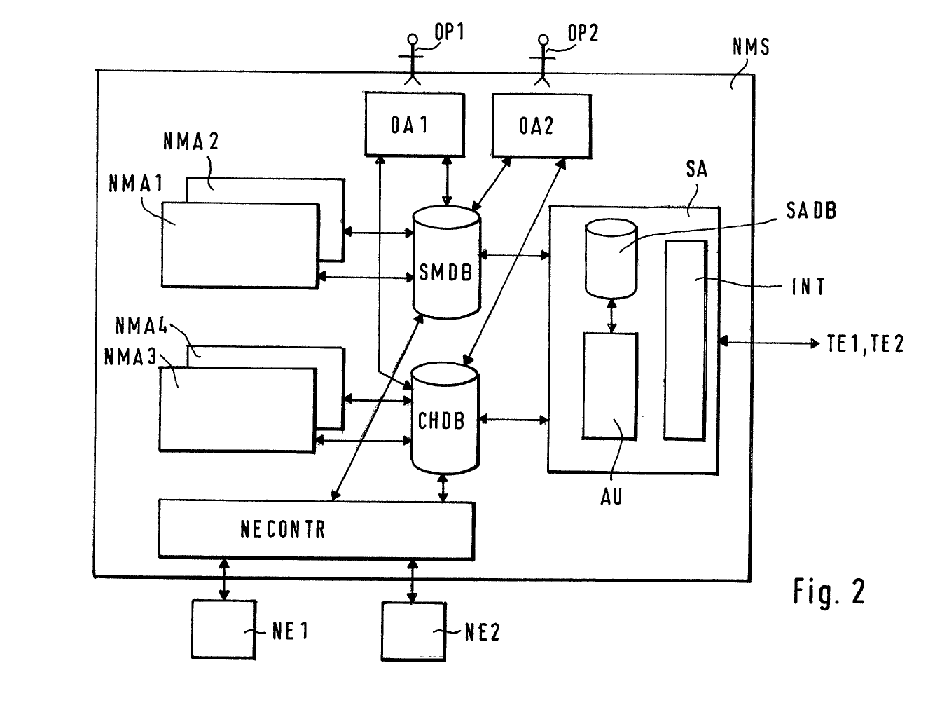

FIG. 2 shows a functional representation of the network management server of FIG. 1.

FIG. 1 shows three communication networks KN1 to KN3, several network management servers NMS1 to NMS3, a network gateway unit GW and three mobile radio terminals TE1 to TE3 that are assigned to a subscriber A, B and C, respectively. The network management servers NMS1 to NMS3 form a network management system NMS. The number of mobile radio terminals, subscribers and network management servers is chosen by way of example.

The communication network KN2 facilitates communication between the mobile terminals TE1 to TE3. The communication network KN1 is formed by a mobile radio network, for example a cellular radio network conforming to the GSM (Global System Mobile Communication) or UMTS (Universal Mobile Telecommunication System) standard. It is also possible for the communication network KN2 to include one or more additional telephone networks (mobile radio networks or fixed networks) or data networks, which can also be assigned to different network operators.

The communication network KN1 is formed by a mobile radio network, for example a cellular mobile radio network conforming to the GSM standard or UMTS standard or a fixed network, for example an ISDN (Integrated Services Digital Network) or a PSTN (Public Switched Telephone Network). It is also possible for the communication network KN1 to include one or more additional telephone networks (mobile radio networks or fixed networks) or a data network (for example for voice over IP), which can also be assigned to different network operators.

Furthermore, it is also possible for the communication networks KN1 to KN2 to be formed from one and the same communication network.

There is a further option in that the communication network KN1 involves a pure data network. Such a data network uses ATM (Asynchronous Transfer Mode) and LAN (Local Area Access Network) protocols as layer 2 communication protocols, for example Ethernet protocols, and an IP protocol as layer 3 protocols. Speech (voice over IP) or video communication can also be conducted over such a data network.

In the case of the communication network KN3, this is a data network which uses the IP protocol (Internet protocol) as layer 3 communication protocol.

The network management servers NMSI to NMS3 provide the network management functions for the communication network KN1 and in their entirety form the network management system NMS which manages the communication network KN1 and the services (communication services and other services) provided in the communication network KN1. It is also possible for the network management system NMS to contain only one network management server. The network management servers NMS1 to NMS3 interact with each other to provide the network management functions and communicate with the network elements of the communication network KN1. Obviously it is not necessary for each of the network management servers NMSI to NMS3 to communicate with the network elements of the communication network KN1. In this case network elements are for example switching centres, crossconnects, routers, bridges or gateways of the communication network KN1. For communication with the network element the SNMP protocol (Simple Network Management Protocol) is advantageously used in data networks for example or the CMIP protocol (Common Management Information protocol) is advantageously used in wide area communication networks.

The network management server NMS1 is thus part of a network management system that manages a telephone network. However, it is also possible for the network management server NMS1 to be part of a network management system that manages a data network.

With regard to hardware, each of the network management servers NMS1 to NMS3 is formed from one or more computers linked via a communication medium. A SW system platform, consisting for example of an operating system and a database system, and applications programs are supported by this hardware platform. When running on the hardware and software platform (system platform) the applications programs control the functions of the network management servers NMS1 to NMS3.

The mobile radio terminals TE1 to TE3 are equipped with a functionality that allows them to communicate by means of a WAP protocol with the network management server NMS1 via the network gateway unit. In the context of this invention, in this case the term WAP protocol stands for a protocol which facilitates the transmission of XML (Extended Markup Language) content, for example WTML (Wireless Terminal Markup Language) or HTML (Hypertext Markup Language) via the radio interface of a cellular radio network. Examples of a WAP protocol are the Wireless Application Protocol (WAP) based on the GSM standard or corresponding protocols of the UMTS standard for the transmission of XML content via the radio interface in a UMTS communication system.

In the case of the subscribers A to C, these are subscribers of the communication network KN1. This means that each of the subscribers A to C is registered as a user of the communication network KN1 or has subscribed to services of the communication network KN1. For example each therefore has at least one terminal which is directly or indirectly connected to the communication network.

In the case of the network gateway unit GW this is a gateway which facilitates the setting-up of data links from the communication network KN2 to the communication network KN3. In this case it is also possible for the network gateway unit GW to carry out a conversion of XML content transported beyond this network limit, for example WTML content into HTML content and vice versa.

The subscriber A initiates the access to the network management server NMS1, for example by pressing a sequence of input keys of the mobile radio terminal TE1 or by a voice command to the mobile radio terminal TE1.

As a result of this, the mobile radio terminal TE1 initiates the setting-up of a communication connection between the mobile radio terminal TE1 of subscriber A of the communication network KN1 and the network management server NMS1 of the communication network KN1. The mobile radio terminal TE1 and the network management server NMS1 communicate over the initiated communication connection by means of the WAP protocol. The network management server NMS1 determines the identity of the subscriber, that is to say the identity of subscriber A, and checks the authorisation of the ascertained subscriber by means of an authorisation procedure. With satisfactory authorisation the network management server NMS1 allows and facilitates access by means of the WAP protocol for the mobile radio terminal TE1 to the data assigned to the ascertained subscriber of a subscriber management database of the network management system NMS of the communication network KN1. The subscriber management database of the network management system NMS is that database of the network management system NMS in which the type of services subscribed to by the subscriber within the communication network, and respective assigned parameters for the management of the communication network, are specified by the network management system NMS.

A possible detailed construction of the network management server NMS1 and the process for supporting the management of the communication network KN1 is now explained by way of example in FIG. 2.

From an operational point of view, the network management system NMS has, among other things, a subscriber access unit SA, several operator access units OA1 and OA2, several network management applications NMA1 to NMA4, a network control unit NECONTR, a subscriber management database SMDB and a call charge database CHDB. By way of example, FIG. 2 also shows two network elements NE1 and NE2 of the communication network KN1.

The operator access units OA1 and OA2 allow access by operating personnel of the network operator of the communication network KN1 to the subscriber management database SMDB and to the call charge database CHDB.

The network control unit NECONTR maintains the connection to the network elements of the communication network KN1, that is to say to the network elements NE1 and NE2, controls these network elements and receives status data from these network elements. The network control unit NECONTR reads data stored in the subscriber management database SMDB and controls the network elements NE1 and NE2 is such a way that services are provided to the subscribers of the communication network KN1 according to the data stored for this purpose in the subscriber management database SMDB. Furthermore, it modifies data stored in the subscriber management database SMDB and the call charge database CHDB when it receives appropriate information from the network elements NE1 and NE2. For example, it modifies data stored in the call charge database CHDB if it receives call charge information from the network elements NE1 and NE2.

The network management applications NMA1 to NMA4 represent applications, each of which carries out special tasks under the provision of network management functions. Examples of such tasks are call charge billing, call charge collection, fault management, QoS (Quality of Service) management, configuration management and problem management. The number of network management applications NMA1 to NMA4 is chosen by way of example. While fulfilling their task the network management applications NMA1 to NMA2 access the subscriber management database SMDB, read data from this database and possibly modify data stored in the subscriber management database SMDB. While fulfilling their task, the network management applications NMA3 to NMA4 access the call charge database CHDB, read data from this database and possibly modify data stored in the call charge database CHDB.

Under special conditions, the subscriber access unit SA allows subscribers access, by means of the WAP protocol, to special data stored in special databases of the network management system NMS, namely the subscriber management database SMDB or call charge database CHDB. In this connection it is also possible that no access to the call charge database CHDB is possible via the subscriber access unit SA.

Those data of the network management system NMS by which the type of services subscribed to by the subscriber within the communication network, and respective assigned parameters for the management of the communication network KN, are specified by the network management system NMS, are stored in the subscriber management database SMDB. Furthermore, further subscriber-specific parameters, for example parameters which represent global parameters for all services of a subscriber, are also stored in the subscriber management database SMDB.

The charges incurred for the use of services of the communication network are stored in the call charge database CHDB.

From an operational point of view, the subscriber access unit SA has a subscriber access database SADB, a control unit AU and an interface unit INT.

At least the functions of the control unit AU and the interface unit INT are provided by the hardware and software components of the network management server NMS1. Obviously it is also possible for more of the functional components shown in FIG. 2 to be provided by the network management server NMS1. It is therefore also possible for all functional components of the network management system NMS shown in FIG. 2 to be provided by the network management server NMS1.

The interface unit INT1 is used for communication with the mobile radio terminals of subscribers of the communication network KN1 by means of the WAP protocol, that is to say with the mobile radio terminals TE1 to TE3, for example.

The interface unit INT thus has the necessary components for processing the protocol stack of the communication network KN3, that is to say for processing an ATM protocol as layer 2 protocol and the TCP/IP (Transmission Control Protocol/Internet Protocol). Furthermore, the interface unit has a browser for interpretation of XML content, that is adapted to the peculiarities of communication of XML content by means of the WAP protocol. Preferably, the interface unit INT has a WAP interface that processes the WAP protocol stack. But it is also possible for the network gateway unit GW to function as a WAP gateway so that processing of the WAP protocol by the interface unit INT is no longer necessary.

When the setting-up of a communication connection from a mobile radio terminal of a subscriber of the communication network KN1 to the network management server NMS1 is initiated, the control unit AU determines the identity of this subscriber. The control unit AU then checks the authorisation of the ascertained subscriber by means of an authorisation procedure.

In order to provide these functions, the control unit AU accesses subscriber-specific identification and authorisation data stored in the subscriber access database SADB.

The identification of the subscriber can be realised, for example, by the control unit AU requesting the mobile radio terminal to transmit a subscriber-specific or terminal-specific identification code to the access unit AU1. An identification code can consist of a telephone number assigned to the subscriber or the name of the subscriber, for example. It is also possible for the control unit AU to evaluate an identification code automatically sent with the request.

To identify the subscribers, for each internal network management subscriber identification code, that subscriber-specific or terminal-specific identification code by which a subscriber identifies himself to the control unit AU, is stored in the subscriber access database SADB. It is also possible for these identification codes to be modified by the respective subscribers.

The control unit AU carries out the authorisation of the subscriber by requesting the mobile radio terminal to transmit a password assigned to the identification code, for example. A further option is to implement authorisation by means of an asynchronous key. The control unit AU transmits a random number to the mobile radio terminal, which is encrypted by the latter with a subscriber-specific or terminal-specific key and is then sent back to the control unit AU. The control unit AU can then check by means of a public key whether or not the mobile terminal is authorised.

Moreover, it is advantageous that, after determining the subscriber, the control unit checks whether the ascertained subscriber is listed in one of the lists stored in the subscriber access database SADB, and authorised to access data in the subscriber management database SMDB and call charge database CHDB. For this, a data record which describes the access options (read/modify) and the type of data to which this subscriber is allowed access, can be stored for each authorised subscriber in the subscriber database SADB.

With satisfactory authorisation the control unit AU then allows and facilitates, for the mobile radio terminal initiating the communication connection, access by means of the WAP protocol to data assigned to the ascertained subscriber in the subscriber management database SMDB of the network management system NMS, in which the type of services subscribed to by the subscriber within the communication network, and respective assigned parameters for the management of the communication network, are specified by the network management system NMS.

For this the control unit AU determines the memory area of the subscriber management database SMDB in which the data assigned to the ascertained subscriber, which specify the type of services subscribed to by the subscriber within the communication network, and respective assigned parameters, are stored. According to the data stored in the access database, the control unit AU then makes it possible for the mobile radio terminal to read and modify data from this memory area of the subscriber management database SMDB within a dialogue based on the exchange of XML content transported by means of the WAP protocol. In this connection it is advantageous if the control unit AU carries out a subscriber-specific mapping of this data area.

With such an access to the subscriber management database SMDB, by modifying such data the mobile radio terminal (TE1 to TE3) can modify the services provided to the ascertained subscriber in the communication network KN1, by deleting or adding services in the subscriber management database SMDB. In this case services can be communication services, but also other services which can be provided to a subscriber within the communication network KN1.

By modifying parameters assigned to respective services, the quality of service agreed for a service can be modified by the mobile radio terminal, for example, and other service parameters, for example VPN (Virtual Private Network) parameters, can be modified.

It is furthermore also possible, during access to the subscriber management database, for the mobile radio terminal to modify the charging of services provided to the subscriber in the communication network KN1, by modifying parameters assigned to services in the subscriber management database SMDB. For example it can modify the tariff specified for a specific service.

It is furthermore also possible, during access to the subscriber management database SMDB, for the mobile radio terminal to modify the collection of charges incurred by the subscriber in the communication network, by modifying global parameters assigned to the subscriber in the subscriber management database SMDB. For example the mobile radio terminal can change the bank via which the services provided to the ascertained subscriber within the communication network KN1 are charged for and the associated charges collected from the ascertained subscriber.

Furthermore, with satisfactory authorisation, the control unit AU allows and facilitates for the mobile radio terminal access by means of the WAP protocol to data assigned to the ascertained subscriber in the call charge database CHDB of the communication network KN1, in which the charges due for the use of services of the communication network KN1 are stored. By means of this functionality, the subscriber can thus obtain an overview of the costs incurred for services within the communication network KN1.

1. Method for supporting the management of a communication network (KN1), characterized in that the setting-up of a communication connection between a mobile radio terminal (TE1 to TE3) of a subscriber (A, B, C) of the communication network (KN1) and a network management server (NMS1) of the communication network (KN1) is initiated by the mobile radio terminal (TE1 to TE3), that the network management server (NMS1) communicates with the mobile radio terminal (TE1 to TE3) via the initiated communication connection by means of a WAP protocol, that the network management server (NMS1) determines the identity of the subscriber (A, B, C) and checks the authorisation of the ascertained subscriber (A, B, C) by means of an authorisation procedure, that with satisfactory authorisation the network management server (NMS1) allows and facilitates access by means of the WAP protocol for the mobile radio terminal (TE1 to TE3) to data assigned to the ascertained subscriber (A, B, C), of a subscriber management database (SMDB) of the network management system (NMS) of the communication network (KN1), in which the type of services within the communication network subscribed to by the subscriber, and respective assigned parameters for the management of the communication network, are specified by the network management system.

2. Method according to claim 1, characterised in that during access to the subscriber management database (SMDB) the mobile radio terminal (TE1 to TE3) modifies the services provided to the subscriber in the communications network (KN1) by deleting or adding services in the subscriber management database.

3. Method according to claim 1, characterised in that during access to the subscriber management database the mobile radio terminal (TE1 to TE3) modifies the charges for services provided to the subscriber in the communication network (KN1) by modifying parameters assigned to services in the subscriber management database (SMDB).

4. Method according to claim 1, characterised in that during access to the subscriber management database the mobile radio terminal (TE1 to TE3) modifies the collection of the call charges incurred by the subscriber in the communication network (KN1) by modifying the global parameters assigned to the subscriber in the subscriber management database (SMDB).

5. Method according to claim 1, characterised in that with satisfactory authorisation the network management server (NMS1) allows and facilitates access by means of the WAP protocol for the mobile radio terminal (TE1 to TE3) to data assigned to the ascertained subscriber, of a call charge database (CHDB) of the communication network (KN1), in which charges incurred for the use of services of the communication network are stored.

6. Method according to claim 1, characterised in that communication between the mobile radio terminal and the network management server is carried out via a WAP gateway.

7. Method according to claim 1, characterised in that the network management server has a WAP interface.

8. Network management server (NMS1) for supporting the management of a communication network (KN1), characterised in that the network management server (NMS1) is provided with an interface unit (INT) for communication with mobile radio terminals (TE1 to TE3) of subscribers (A, B, C) of the communication network (KN1) by means of a WAP protocol, that the network management server (NMS1) is provided with a control unit (AU) that is configured so that when the setting-up of a communication connection from a mobile radio terminal (TE1 to TE3) of a subscriber (A, B, C) of the communication network (KN1) to the network management server (NMS1) is initiated, the control unit determines the identity of the subscriber (A, B, C) and checks the authorisation of the ascertained subscriber (A, B, C) by means of an authorisation procedure, and that the control unit is further configured so that, with satisfactory authorisation it allows and facilitates access by means of a WAP protocol for the mobile radio terminal (TE1 to TE3) initiating the communication connection to data assigned to the ascertained subscriber (A, B, C), of a subscriber management database (SMDB) of the network management system (NMS) of the communication network (KN1), in which subscriber management database the type of services within the communication network subscribed to by the subscriber, and respective assigned parameters for the management of the communication network, are specified by the network management system.

9. Network management server according to claim 8, characterised in that the network management server (NMS1) is part of a network management system (NMS) that manages a telephone network.

10. Network management server according to claim 8, characterised in that the network management server is part of a network management system that manages a data network.
